(19) United States
(12) Patent Application Publication
(10) Pub. No.: US 2004/0158523 A1
(43) Pub. Date: Aug. 12, 2004

(54) Method providing contingency access to valuable accounts or information

(76) Inventor: David Bogart Dort, Washington, DC (US)

Correspondence Address: VRBIA PATENT PLLC, BOX 66148 WASHINGTON SQUARE STATION, WASHINGTON, DC, 20035, US

(21) Appl. No.: 10/359,473

(22) Filed: Feb. 6, 2003

(51) Int. Cl. G06F 17/60

(52) U.S. Cl. 705/42

(57) ABSTRACT

The invention teaches an improved security system for accounts accessed over a network, where the account holder is provided with an alternate security code, usually related to a PIN. During an assault or kidnapping, the alternate security code can be placed into the system without the detection of the assailant, implementing a contingency scenario which protects the assets available over the network and executes instructions to protect the account holder.

### BACKGROUND

Personal security issues surrounding kidnappings relating to secure accounts and other valuable assets or information have become increasingly difficult as electronic access to accounts and information becomes ubiquitous from not only standard network access points, but home network access, wireless communication devices, and access points

FIG. 1 depicts a simplified block diagram of an account access network system 200 of the prior art. Such a system includes one or more Automatic Teller Machines (ATMs) 10, which are connected through a connection 50 to a network 100 which may include one or more vendor access systems, 110a, 110b, . . . , or simply be able to access the vendor access systems 110a, 110b, . . . , through a network connection, 60a, 60b, . . . .

The ATM 10 includes a display 11, internal connection bus 12, one or more manual dispensers or inserts 13, a numeric keypad 14, an optional keyboard 15A, specialty buttons 15B, or touchscreen devices 15C, a card insert 16, a dispenser 17, a computer 18 which is connected to the internal bus 11, and a network connector 19. The ATM also may include a security system 40, which includes a monitoring system 20, which usually includes a camera 22. The monitoring system 20 is connected through a convention or digital connector 24, such as a coaxial cable or a digital connection to a security monitor or router 26. The security monitor 26 may be connection to a conventional security display 30 that is watched by a security guard at a security station 31. The monitor 26 may also be connected to an analog or digital recorder 29, which records the events before the camera 22 on analog or digital media 35. The security system 40 may also include a panic button 2 or panic speaker/microphone 4 located on the ATM 10. Both the panic button 2 and speaker/microphone 4 may be connected to the security station 31, through a dedicated connection 5, or to a security network 6, which may an outside security system 98, such as contacting the authorities or a third party security company. In some security systems 40, the monitor 26 may be connected to a digital monitor and decision making device 27 which automates the observation through the camera 22 and detects when a problem event is taking place. However this technology is still in development.

Each vendor access system 110a, 110b, . . . includes a network connection 60a, 60b, . . . , a computational system 140a, 140b, . . . . Each computational system 140a, 140b, . . . may include one or more general purpose of specialized microprocessors 150a, 150b, and data storage 160a, 160b, . . . . Each vendor access system 110a, 110b, . . . may itself include a sub-network 120a, 120b, . . . to connect multiple vendor access systems for a single vendor or multiple vendors. In such a case a single sub-network 120a, 120b, may overlap with a main network 100 or other subnetworks. The ATM 10 may be locally connected to a vendor access system 110a, by a local connection 55. Usually, these situations are the use of intrabank ATMs or where the user's account matches the owner of the ATM (or there is a cooperative system).

A user of the ATM 10 inserts an account card in the card insert 16, and is then prompted for a PIN by the display 12. The PIN is entered on the keypad 14. Depending on the particular configuration of the ATM 10, the user may be allowed to continue the banking transaction, even if the PIN is incorrect. The PIN and other transaction information are entered into input devices 15A, B, or C. The information from the account card may be processed by the ATM processor 18. The PIN and account information are sent to a network 100 via a communication device 19 and a network connection 50. A network 100 may be a large conglomerate of access networks or an individual system such as CIRRUS®, PLUS® or MOST®. Most consumers will have more that one network accessed by their account card. As can be appreciated by those skilled in art, networks 100 may include many different discrete and overlapping configurations.

The PIN and the account information is properly routed to the appropriate subnetwork 120a, 120b, . . . where the information is processed by a vendor access system 110a, 110b, . . . . Input PINs may be compared by the computational system 140a, 140b, to the correct PIN for the account in data storage 160a, 160b. Incorrect PINs will be reported back through the network 100 to the ATM processor 18 which will then terminate the transaction or prompt the user for another PIN. Other situations based on the information in storage 160a, 160b, . . . , such as account balance, daily withdrawal limits, holds, etc. may also terminate the transaction. Where a PIN is correctly entered and a successful transaction occurs, the account information is usually allowed to pass through the network 100, but not always. Such information may not be available where an ATM 10 is used which is not part of a particular network 100, even though cash may be accessed by the user.

The number of kidnappings in foreign countries related to “ATM hijackings” is exponentially rising. For example, in Mexico City, Mexico, false cab drivers will take tourists to ATM machines and require them to withdraw all the funds available to them under threat of bodily harm or death. After obtaining money, the kidnappers may leave the tourist alone, or upon finding out they have more money available to them the next day, will simply hold the tourist for an indefinite period until the account is drained.

Many banks have a “daily limit” on ATM can help prevent fraud or waste. However, kidnappers who come to know that an individual has $10,000 in a checking account and a daily limit of $500 will be more tempted to either hold the individual until more money is withdrawn, either harm or blackmail the individual (i.e. threaten, stalk) until the money has been delivered or in a worst case scenario torture the victim for their PIN.

Monitoring an account may be helpful to prevent fraud over the course of hours or days. This prior art technology is based on the principle that “unusual” activity will trigger a Bayesian logic program. Often a bank or credit card company will call a customer to confirm that the unusual activity has been authorized.

Furthermore, the increasing ubiquity of PINs and passwords for access in daily life for more than just conventional ATMs makes an increasing number of PIN users succeptible to “hijackings” of all sorts, including Internet-accessed accounts and information and security checkpoints of all sorts, of which, may include national defense situations.

Also, It is well-known that individuals who are under distress may attempt to reach authorities for “help” at heightened risk to their personal safety, whether the situation be involved a personal risk because of the anger of the bad actor directed to the victim, or because authorities are often not properly trained to deal with such situations.

While Personal Identification Numbers (PINs) have been in mainstream use since the wide implementation of the Automatic Teller Machine (ATM) in the mid 1970s, other, biometrically-related access systems are now coming into the mainstream with the improved availability of scanning and recognition devices. Such access system include voice printing, retinal scanning, finger/palm print scanning and more. Other types of access devices which have become widespread are related to the Internet and/or telephonic access to a system which usually require entry of passwords and/or PINs.

Other security measures have been tried to prevent danger to a consumer, such as cameras located on ATMs, panic buttons, emergency speakers, etc. These have limitation and dangers, as they may be useful after the fact or notify an observant bad actor that an “alarm” has been set, which may provide great risk to the consumer. Personal security devices may be connected to cellular of PCS telephones, and may also use GPS or other locating devices, however, these are purely “notification” devices at present and are not combined with systems that protect valuable assets. Also, such systems are expensive. Secure information acquires over the Internet usually requires one or more passwords.

An invention is needed which provides protection for valuable assets and/or notifies a third party that a high-risk situation is happening while not allowing an observing bad actor to notice realize that such protection and notification is taking place.

### SUMMARY

The present invention to provide a system which allows a user to implement contingency plans discretely without notice to a potential bad actor or observer. In the preferred embodiment a user is provides a contingency security code which is unrecognizable to a bad actor who may respond violently knowing that the victim has not complied with demands. In a preferred embodiment, the contingency code is usually an easily remembered variation of a user's PIN, but is not easily recognizable to the observant bad actor.

The present invention to allow implementation at local and network levels to provide additional security for entities that may not participate in the contingency safety program. The invention allows for entry of the contingency system into a network by having different physical embodiments. For example, in a large system with multiple vendors (such as banks) in which there is only one participant, the system can be inserted without disruption to the network.

The present invention creates a fictitious “scenario” which allows for the consistent appearance that the alternate access scenario is operating normally. Thus, by implementing the contingency code, a user can potentially thwart one or more disastrous results: (1) the observant bad actor is placated and (2) most of the assets, either monetary or informational are protected by the implementation of the contingency code. Optionally, notification of the third party without notice to an observing bad actor may be included as part of the scenario.

The present invention allows for an increasingly complex set of alternate scenarios depending on the desires and circumstances of a user. It is recognized that the field of personal safety is an uncertain one, and any give user may have preferences based on strengths or experiences. This present invention allows the user to have flexibility in order to meet the needs of different consumers.

The need for the inventive multiplicity of discrete contingency scenarios will likely only increase as information become accessed from more and more electronic entry points. The invention contemplates the need for providing non-alphanumeric contingency implementation as well, such as voice inflections, alternate fingerprints, notifying eye movements, can all be appreciated as implementing the protective contingency code.

### BRIEF DESCRIPTION OF THE DRAWINGS

The invention can be more easily understood by the following drawings and diagrams, in which:

FIG. 1 represents prior art ATM security, well known in the art for several decades as it currently may be implemented;

FIG. 2 represents logic at the ATM level for implementing the present invention;

FIG. 3 represents logic at the network level for implementing the present invention;

FIG. 4 represents a logic system in the present invention implemented at the vendor level.

FIG. 4A represents the system in FIG. 4 in which implementation does not require retrofitting or reprogramming at the individual vendor or network level;

FIG. 4B represent the system in FIG. 4, in which implementation is incorporated into a vendors' access system.

FIGS. 5A, B, and C represent a method for implementing the alternate access scenario in a flow diagram for the systems in FIGS. 2, 3 and 4 respectively;

FIG. 6 represents a block diagram for implementing the invention based on a smart card;

FIG. 7 is a flow chart of the method of programming the present invention with a smart card implementation;

FIG. 8 represents a flowchart of a scenario in a preferred embodiment of the invention;

FIG. 9 represents a flowchart of a complex scenario in an alternate embodiment of the invention;

FIG. 10 represents a block diagram of the present invention as it may be implemented on an Internet accessible security account;

FIG. 11 represents a block diagram and flow chart of the invention as it may be applied to different industries;

FIG. 12 depicts the system as it may be applied to biometric access devices;

FIG. 12A depicts the system as it may be applied to voice print identification;

FIG. 12B depicts the system as it may be applied to retinal scans; and

FIG. 12C depicts the system as it may be applied to fingerprint or palm print scans.

FIG. 13 is a block diagram of the invention at the conceptual level.

### DETAILED DESCRIPTION OF THE DRAWINGS

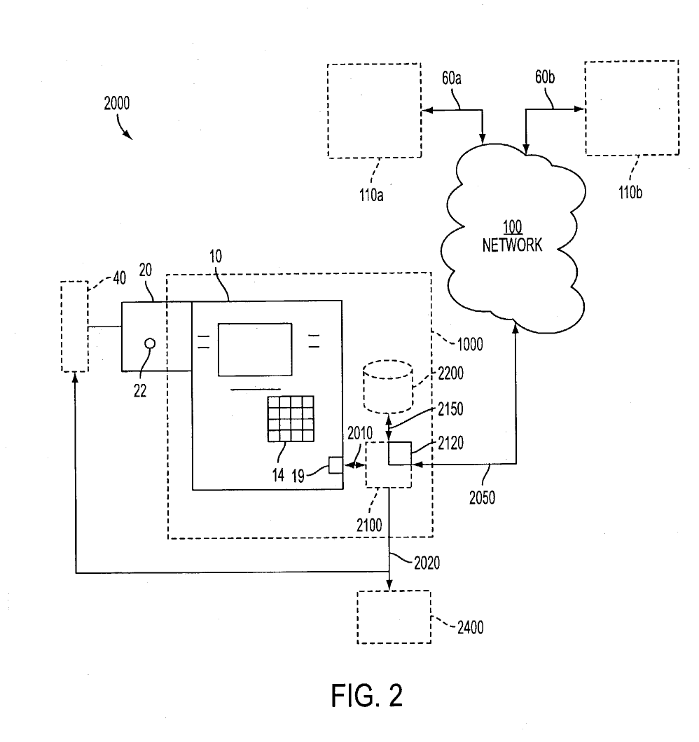

Referring now to FIG. 2, a simplified block diagram of a preferred embodiment of the invention 2000 is shown. The contingency security system 1000 is implemented at the pre-network 100 or local level and may be used for one or more ATMs 10. The local level contingency security system 1000 includes a decision device 2100, which may include one or more specialized microprocessors 2120 and is connected to the one or more ATMs 10 through a local connection 2010. The decision device 2100 is connected to data storage 2200 by an internal or external bus 2150, as the data storage 2200 can be located in the decision device 2100. The decision device is connected to a network 100 and vendor access systems 110 through a single or multiple network connections 2050. Optionally, a security notification system 1002 is part of the system 1000. The decision device 2100 is connected to a security system 40 or a notification protocol system 2400 by a connection 2020.

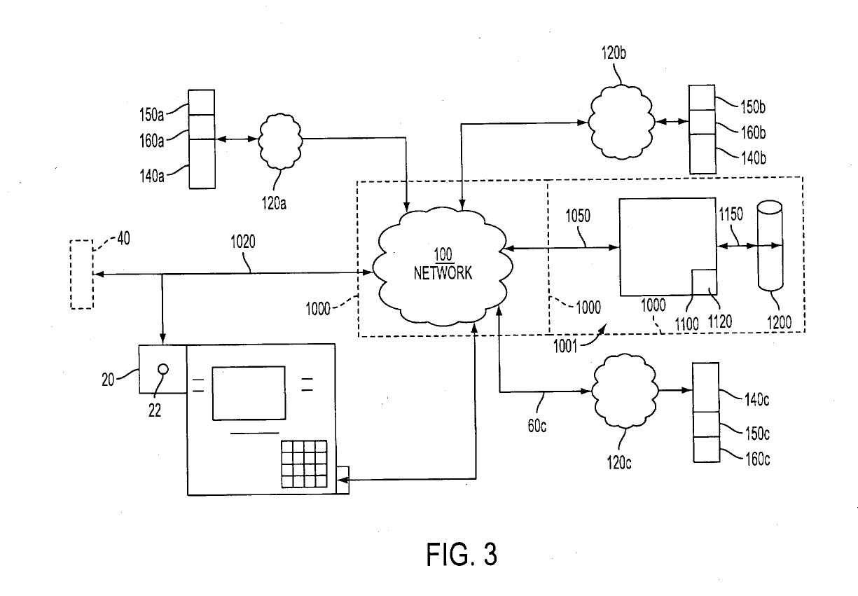

Referring now to FIG. 3 the system of the invention in a preferred embodiment is shown. The contingency security system 1000 is located at the network 100 level. The computational part of the system 1001 may be located on a physical decision device 1100 or at nodal points 1101 or virtual spaces 1102 (described below), which is why the system is indicated by dashed lines. The decision device 1100 is similar to that described in FIG. 2 and may include a standard or specialized microprocessor 1120, data storage 1200 and an internal or external connection to the storage 1150. Like shown in FIG. 2, the system 1000 includes a security notification system 1002, which is connects the network 100 to a security system 40 via a data communication line 1020.

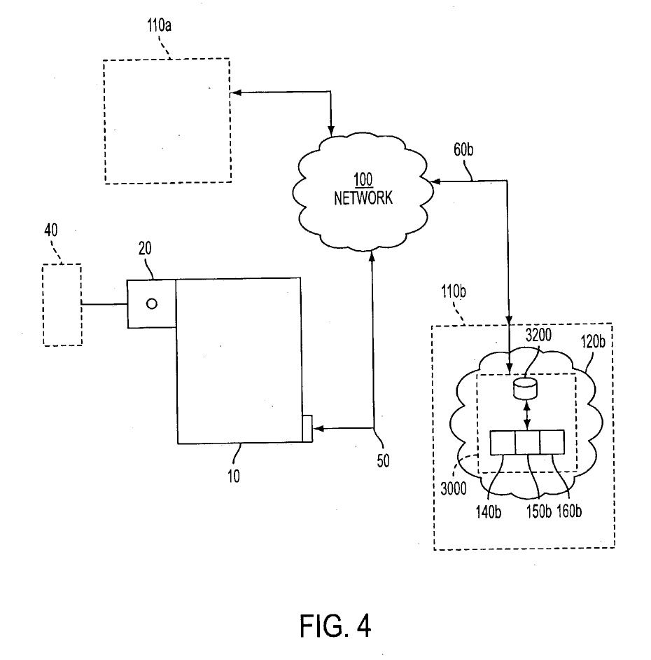

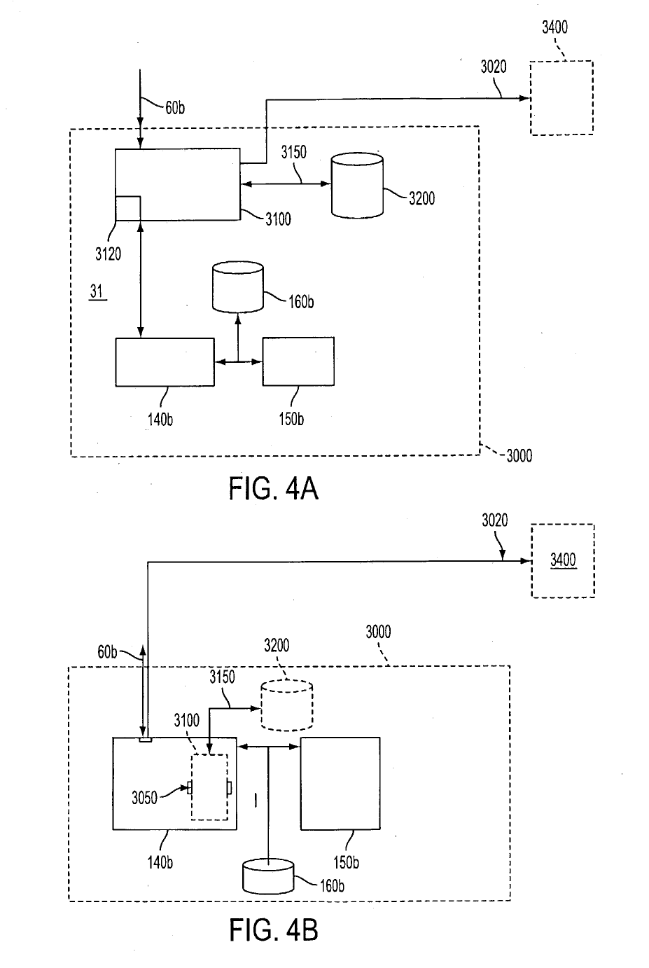

Referring now to FIG. 4, another embodiment of the invention is shown as implemented at the local vendor access system 110a, 110b, . . . level. FIG. 4A depicts an embodiment in which the invention 1000 may be implemented without disturbing existing access system 110a, 10b, . . . , by patching on the system inside the vendor access system but where the decision device 3100 is screening PIN and account data for contingency matches before entering the access system computer 140a, 140b, . . . . The embodiment of the contingency system 1000 shown in FIG. 4A has a particular advantage in that the installation can be executed independent of any networks 100, 120a, 120b, . . . or computational systems 140a, 140b, . . . . However, as can be appreciated by those skilled in the art, the data exchange between the decision device 3100 and the computational system 140a, 140b, . . . in this embodiment may require some additional patch software, but communication protocols used in data transport should be sufficient for this purpose.

FIG. 4B shows the invention where the decision device 3100 and/or the data storage 3200 is located inside the access computational system 140a, 140b, . . . , either as software, embedded software, hardware in the form of an ASIC or part of the another specialized microprocessor device. The implementation of the invention inside the computational system can be implemented in several different ways, as can be appreciated by those skilled in the art.

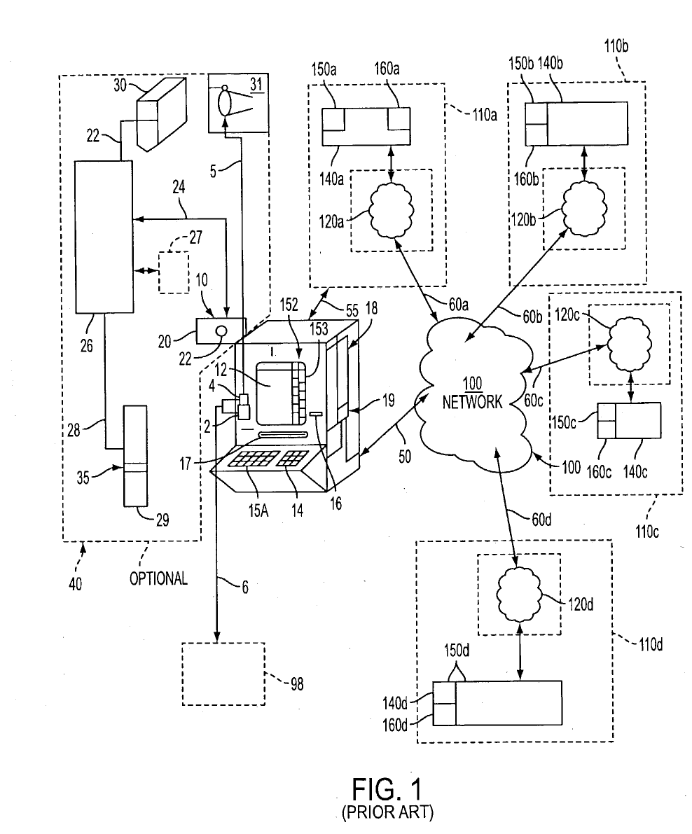

The standard operation of a PIN at an ATM is known in the art and one particular implementation is described in the background section of the application and shown in FIG. 1. Although, as can be appreciated by those skilled in the art of computer networking and security access, the account information can be implemented in ways other than the brief description above.

The present invention may be implemented by the entry of the alternate or contingency security code (also referred to as “alternate PIN”). When the user punches in the alternate PIN on the ATM keypad 16, the account information from the account card is coupled with the alternate PIN and processed by the invention at the local, network, or vendor levels as shown in FIGS. 2, 3 and 4 respectively. While all three implementations are similar, setting the contingency scenario into motion is slightly different at the respective levels.

The contingency security code is sent with account information (contingency information) to the network 100. In the local implementation shown in FIG. 2, the contingency information is intercepted by the decision device 2100, and compared with account data and contingency data in storage 2200 for possible contingency match. Even non-contingency information passes through the decision device 2100 for comparison. Certain factors which are internal to the contingency code may optionally flag a contingency comparison by the decision device 2100, such a matching first and last digit, a flagged PIN ending like “57” or “11.” However, such an internal flag for the contingency code is not needed and only would be used to save computational resources. If a contingency code has not been entered, the transaction may proceed as normal to its conclusion.

If the decision device 2100 detects that a contingency code has been entered, it then loads or executes a contingency scenario. The instructions for executing the scenario may be stored in the local data storage 2200 or programmed into the decision device 2100 or alternately embedded in storage onto the specialized microprocessor 2120 in the decision device 2100 or contained into the hardware itself In an alternate embodiment, the decision device 2100 is simply the detector of a contingency code and queries the vendor access system 110a, 110b, . . . or the network 100 for instructions on the contingency scenario.

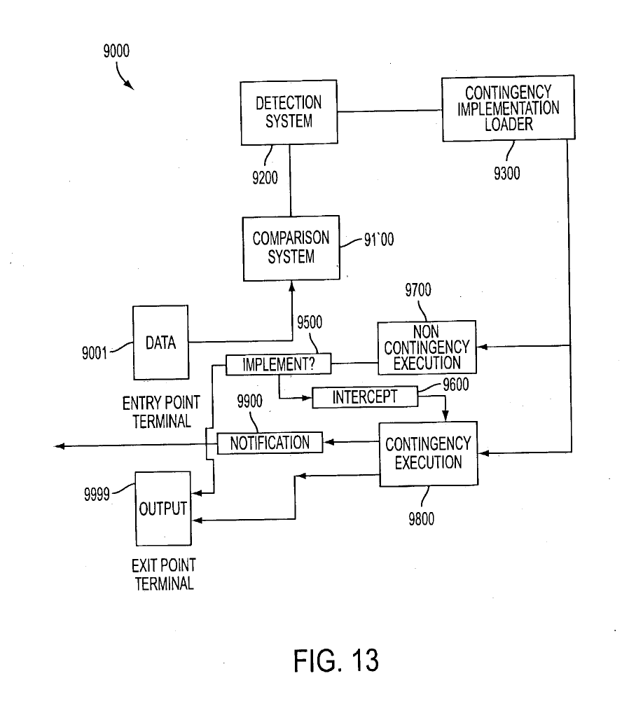

The location of the contingency detection system and contingency scenario instructions do not need to be on the same tier (local, network, subnetwork, vendor, etc.) for the implementation of the invention. Data and networking specialists can appreciate that implementation of the invention over a large network over a period of time will present special problems. The invention provides flexibility in implementation, as it is expected that network or multiple network implementation may occur after local or vendor implementation. An examination of the conceptual block diagram in FIG. 13 allows for an understanding of this principle.

The contingency scenario is loaded into the decision device 2100. The transaction data is then changed to comply with the contingency scenario and sent to the network 100. The transaction is processed by the appropriate vendor access system 110a, 110b, . . . with the substituted data (withdraw $250 instead of $1000). The transaction data returns to the decision device 2100 through the network 100 and the decision device 2100 executes instructions so that the ATM processor 18 or ATM 10 display the substitute access information on the screen 11 or on a receipt. The general principle is that the account balance will show a negligible amount. But other scenarios such as showing an much larger amount than available are also contemplated by the invention.

The contingency scenario intercepted at the network level 100, by the decision device 1100, will also result in the “substitution” of transaction (inbound) and account (outbound) data. The vendor access system implementation depicted in FIGS. 4, 4A and 4B will not require substitute data as the transaction and account data are generally being processed at the source of the information.

Because a detection of a contingency security code by the invention will activate a contingency scenario, which may be stored at the local 2200, network 1200, or vendor 3200 levels. one or more contingency factors can implemented. As can be appreciated by those skilled in the art, contingency factors may be stored in a database in the data storage 2200 or internally embedded in the microprocessor 2120. may be controlled in a typical embodiment of the invention and can include:

•[1] Withdrawal limit: when this contingency factor is activated only a limited amount of money may be taken from the account until re-verified by the user.

•[2] Notification of balance in account(s): when this contingency factor is activated, the receipt from the ATM shows a small balance in the account.

•[3] Blocked access to other related accounts: when this contingency factor is activated.

•[4] Notification of Authorities or private security company

•[5] Location of event

•[6] Proceed with caution notice: puts a third party on notice that a hostile party is still in contact and engagement must proceed with caution.

Of course for other security scenarios accounting other factors may be included and would vary for embodiments of the invention that are not implemented in the ATM use. For example, in the home security contingency plan, account access may not a relevant issue. This is discussed below.

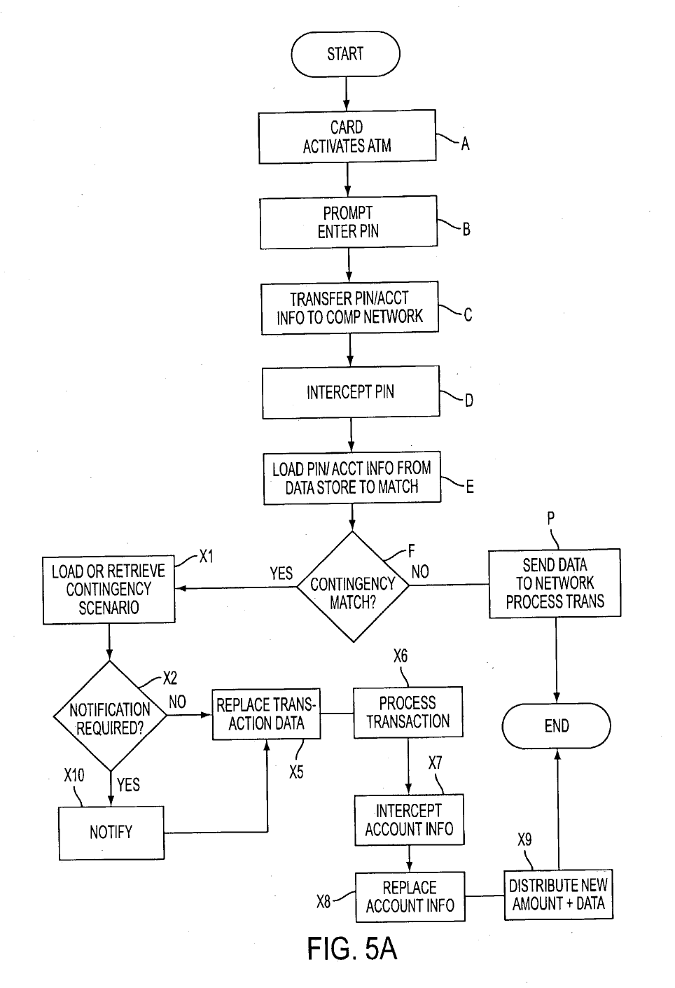

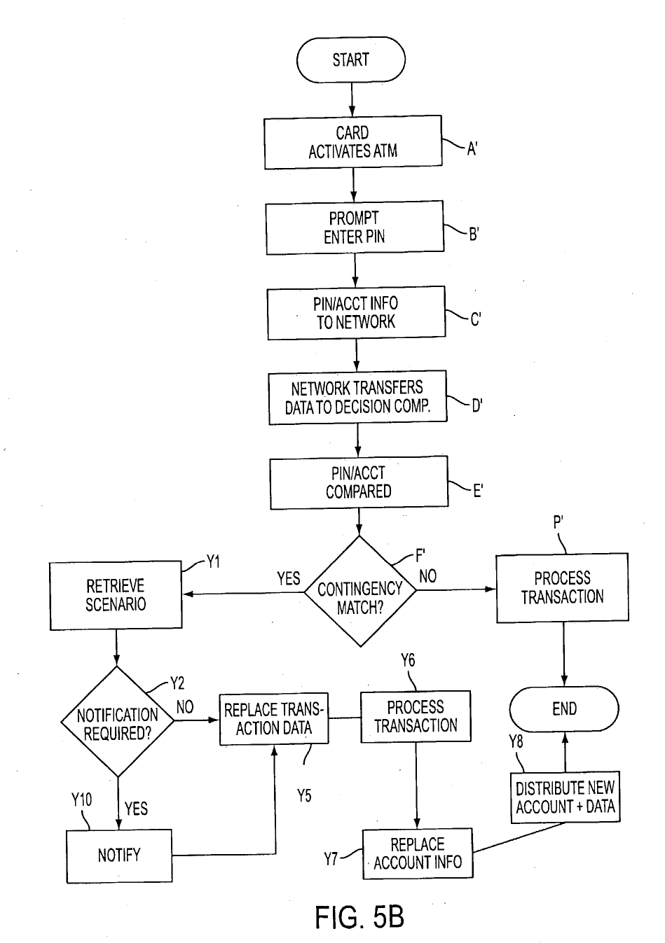

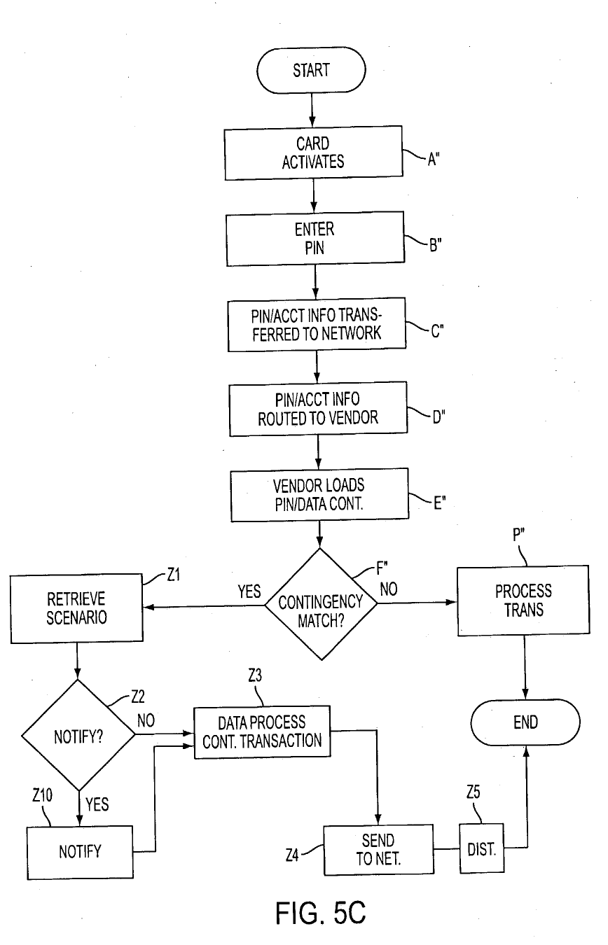

FIGS. 5A-5C depict the method implemented by the three embodiments in FIGS. 2, 3 and 4 respectively. The only difference between the three method is that the local and network implementations (5A and 5B, respectively) must replace transaction data at steps X5 and Y5 before allowing the transaction to proceed to the vendor access system 110a, 110b, . . . , if the respective vendor access systems 110a, 110b, . . . , are not compatible with the data produced by the detection of a contingency code. Where the invention is implemented at the vendor access system 110a, 110b, . . . as shown in FIGS. 4, 4A and 4B, the information is corrected and exchanged at the vendor level and does not need “masking” in order to protect both the assets and the consumer.

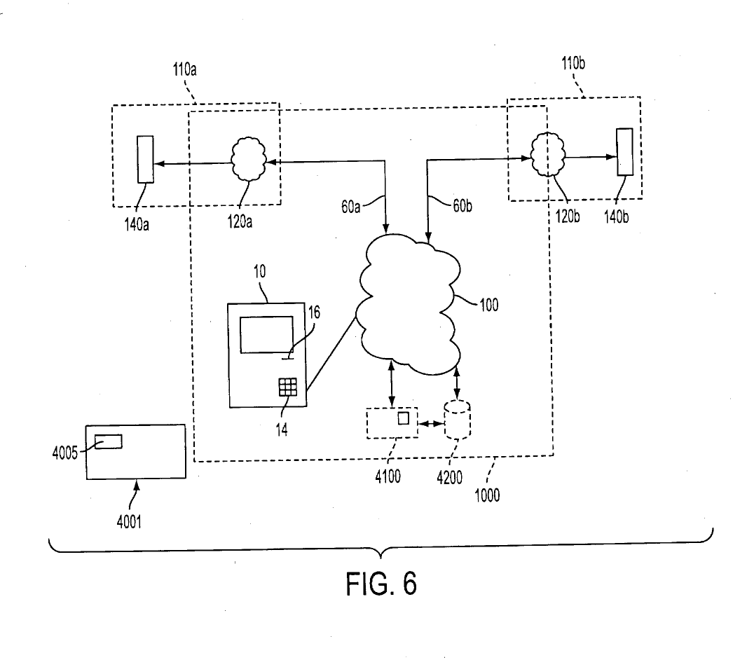

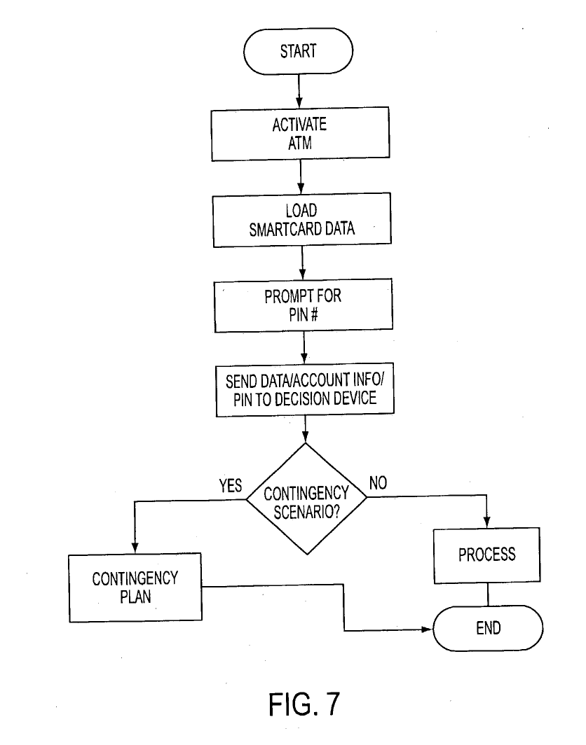

FIG. 6 depicts a block diagram of the invention 1000 as it may be implemented in an embodiment of the invention which uses a smart card 4001 which contains the software in a microchip 4005 necessary for the implementation of the invention. Data is loaded from the smart card 4001 inserted in the card slot 16 into the ATM processor 18 and network 100. The decision device 4100 and optional data storage 4200 can be located anywhere in the system 1000. However, as can be appreciated by those skilled in the art, there must be a part of the system 1000 that can interpret instructions loaded from the smart card 4001 and the ATM 10 must have the capacity to load and transfer such instructions to the system 1000. FIG. 7 shows a flow diagram of the invention as shown in FIG. 6.

Scenario #1

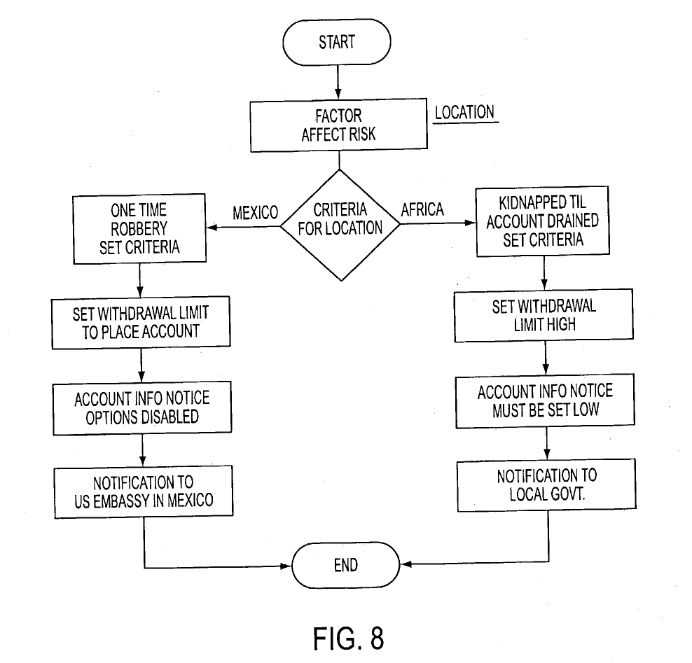

FIG. 8 is a flow chart of the invention used in the following scenario: The individual determines how much would be needed to satisfy the demands of the kidnapper. For example, on a trip to Mexico, there is very little violence after an initial amount is given to the kidnapper, but in an African country, the kidnappers will insist on holding the victim until the account has been drained. Wealthy individuals may wish to set the limit of the alternate access scenario to a desired amount which may be considered as an acceptable loss.

For illustration purposes only, a users main PIN in this application will be 5995. The alternate security code will be 5911. However any number of characters may be used for both the main PIN and the contingency or alternate security code.

Scenario #2

A pedestrian is held up at gunpoint on the street. The assailant forces the pedestrian to go to the nearest ATM and withdraw (all available) cash. Optionally, the pedestrian informs the assailant he has about $500 dollars in his account, but actually has $20,000. Under the observation of the assailant, the pedestrian enters the PIN 5911 and attempts to withdraw $500 in cash, which activates the contingency scenario at the local, network, or vendor access level. The account allows a $500 withdrawal, informs the police of the location of the assault and that caution must be used as a hostage situation may be created. The bank or invention distributes (intentionally false) information to the ATM that the account now has only $14.02 left which either shows up on the screen or the receipt. The assailant leaves with the $500 in cash.

Scenario #3

A user begins to use an ATM for withdrawal, has put in his card but has not punched the PIN, the user notices that suspicious characters are lurking close to the ATM. The user, for safety and preventive reason, punches the 5911 contingency code. The contingency scenario is activated, but no notification to the authorities takes place. The withdraw limit is set at $300. The user withdraws $50 dollars, the display or receipt is prompted such that only $14.02 is left in the account. The user leaves unhindered and the next day resets his account to remove the contingency.

The invention also allows for a other contingency plans which may benefit an individual under distress. For example, if a tourist is kidnapped and there is so little money in the account that the tourist fears that they be a victim of violence, the contingency security code will trigger a small credit line which will placate the kidnapper into letter the tourist go unharmed.

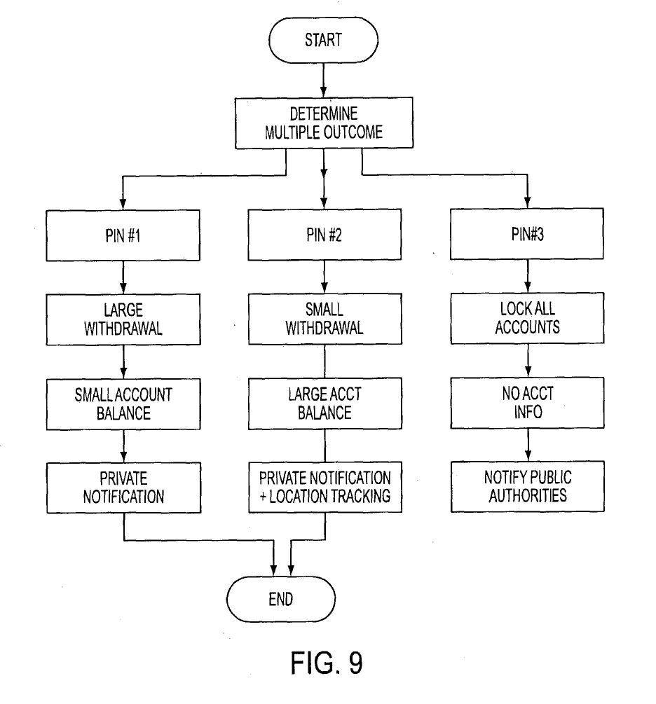

Of course, the level of sophistication of the contingency plane may be adjusted according to the sophistication. For example, wealthy individuals may wish to be allow several different levels of protection. FIG. 9 depicts a flow chart of an example situation in a multiple-scenario contingency system.

The present invention is designed in a preferred embodiment to apply to ATM access, or access to other assets which is based on a security code, however, the alternate scenario ending, unrecognizable by an assailant and may be used in other scenarios that require some degree of placation of bad actors in order to reduce personal danger. For example a home security system which sets off an alarm, may trigger a response by a security company to call the individual home to see if that home has been victimized by a burglary or illegal entry. A victim may wish to placate demands on the bad actor by eliminating the alarm but not wishing to incur the personal risk associates with notifying the proper authorities that the individual continues to be in distress. This can be especially important in a situation where the bad actor is a stalker or other familiar individual who may not simply wish to remove the risk to apprehension.

Scenario #4

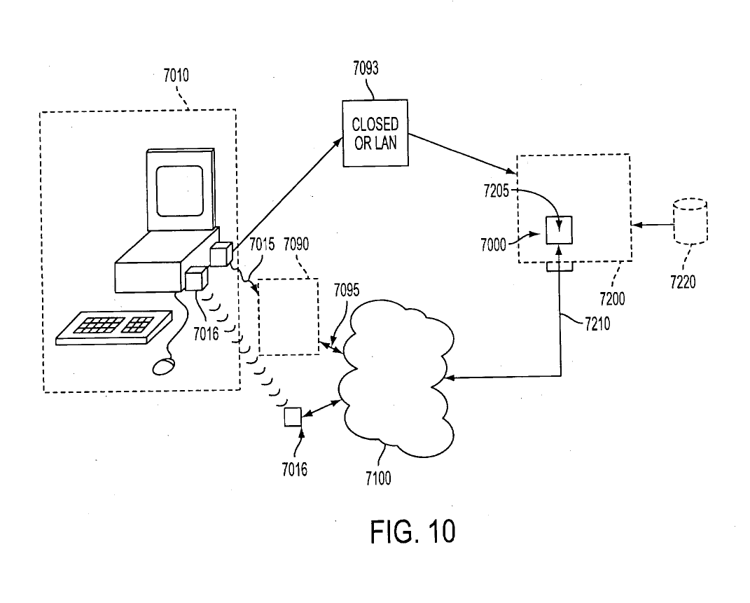

Referring now to FIG. 10, an Internet embodiment of the present invention 7000 is shown. Typically, the victim will accosted at home or an office, in which the bad actors will attempt to get resources from the victim. A home or office computer system 7010 is connected to a WAN 7100 through a communication line 7015 or a wireless access system 7016. This contingency scenario system 7000 can be loaded into the computer 7010 or if the computer 7100 is part of a LAN 7090 is attached to a WAN 7100 or the Internet. The system 7000 may also be part of the LAN 7090, located in between the LAN 7090 and the computer 7010 or between the LAN 7090 and the WAN 7100. It is anticipated that for large commercial, industrial, or government settings the most economical location would implemented at the outgoing point 7095 to the WAN, but other installation may be needed as well. The contingency system 7000 located at or on the vendor access system 7200, whether it be a bank or other industrial or government access point. Like the above embodiments in FIGS. 1-4B, the alternate password or PIN will set in motion a stored contingency scenario. The contingency system 7000 can be located inside the vendor's system 7200 or may be implemented.

Scenario #5

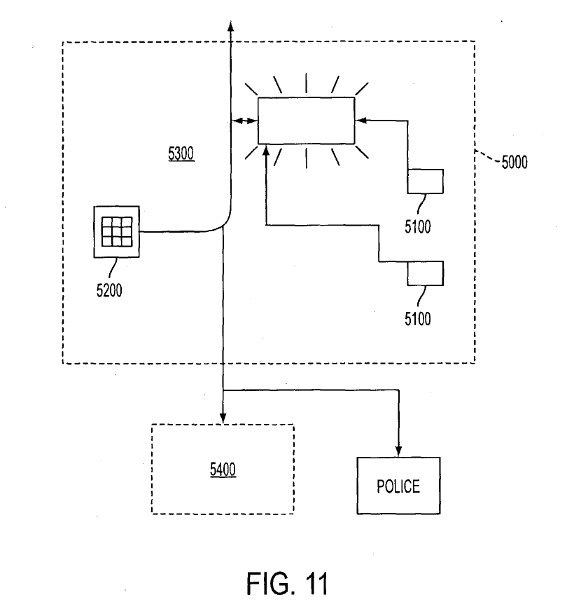

Referring now to FIG. 11, home security system 5000 with security code entry panel 5200 detects all motion in the main floor of a home near all entry point and therefore an intruder cannot move past the motion detector 5100 without setting off the alarm 5300. Illegal home entry occurs and the alarm 5300 is set off notifying a security company 5400 via a communication line 5350 of the intrusion. Knowing that many alarms notify the authorities either directly or indirectly, instead of leaving the premises, the intruder rushes upstairs to thwart any threat. The intruder demands that the resident shut off the alarm 5300 via the code panel 5200. The resident enters 5911, indicating to the security company 5400 or police that a contingency scenario is taking place. Expecting a call from the security company 5400 to check if things are all right, the resident can inform the security company that there is no problem not incurring risk to the resident, if such a judgment is made. In the event that the intruder takes the call and forces the resident to give an secondary security code, there is no clue from the security company operator that the contingency code has already been activated.

The present invention may easily be adapted to the following other scenarios with departing from the spirit and scope of the invention: Home security (home invasion); Cellular and PCS emergency notification (with or without GPS); Defense and intelligence monitoring and security clearance; commercial and industrial information sharing.

In order to simplify a particular embodiment of the invention, a vendor of the invention may wish to limit the contingency scenario to a standard option or narrow list of options. Such an appropriate option may include the following features when the alternate security code is activated within the system:

[symbol] The user can withdraw $500 from the account. [Contingency factor 1A]

[symbol] The balance will read from $20 to $75. [Contingency factor 2]

[symbol] If the user has more than one account, all other accounts are “hidden” or “blacked out.” [Contingency factor 3]

[symbol] The local authorities will be notified that the user is in distress [contingency factor 4]

[symbol] The local authorities are notified of the location of the ATM [contingency factor 5].

Of course, vendors would have the option to implement more complex scenarios if so desired, but in no event should the alternate security code have any identifying characteristics to a hostile observer.

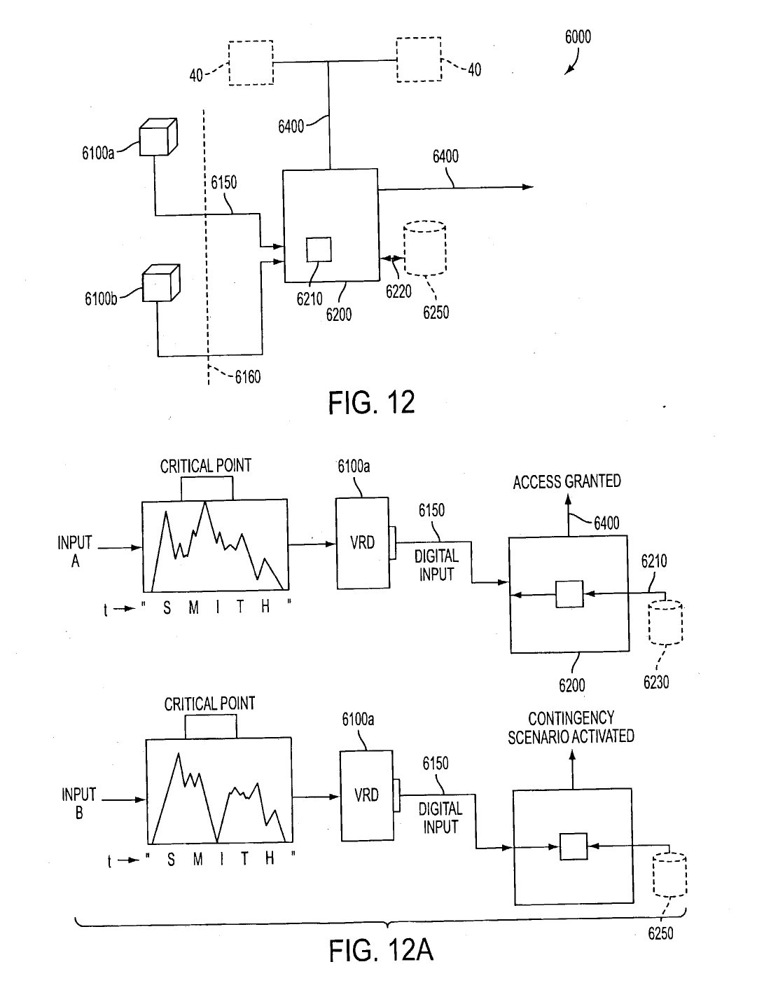

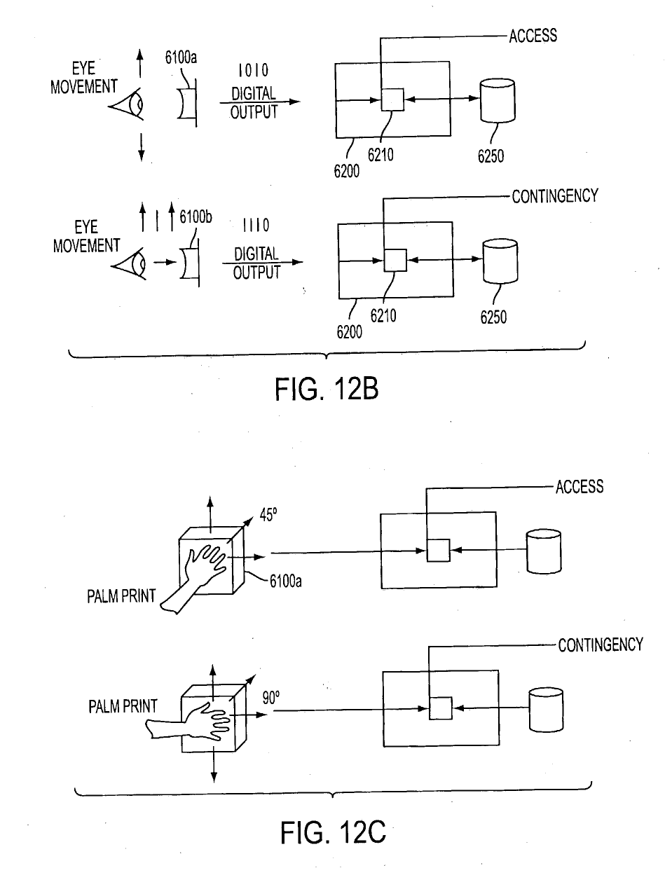

Referring now to FIG. 12, the present invention as may be used in a biometric access system 6000 is shown. This embodiment includes one or more biometric detectors 6100, a decision device 6200 which includes a general or specialized microprocessor 6210, connected to the detector through a local or network connection 6150, and data storage 6250. The connection to the scenario generator 6400 and/or notification system can be through a conventional connection. 6350. FIG. 12A is a block diagram of the invention as implemented in a voice recognition access system, where voice fluctuations or other variation notify a contingency detection system of a contingency situation. FIG. 12B is a block diagram of the invention as implemented in a retinal scanning device, where particular eye movements activate the contingency scenario. FIG. 12C is a block diagram of the invention as implemented in a finger or palm print recognition device where the angle of the main finger activates the contingency scenario.

FIG. 13 illustrates a block diagram conceptual framework of the invention in a particular embodiment.

The above-illustrations are meant to representative only and the spirit and scope of the invention may be applicable for other applications. The invention should be defined by the following claims.

Having thus described my invention, I claim:

1. A contingency security code system including:
an entry point device, said entry device coupled to one or more networks and for gaining access to an account through said one or more networks, said entry point device requiring a first security code for said access;
contingency recognition logic coupled with said one or more networks, wherein said contingency recognition logic will activate if a second security code is entered into said entry point device;
contingency implementation logic coupled with said one or more networks, wherein said contingency implementation logic executes a set of instructions;
wherein said first and second security codes are distinguished from each other.

2. A banking network which includes a set of automatic teller machines (ATMs) coupled with a communication system that allow said set of ATMs to access at least one bank account, wherein said at least one account may be accessed by inserting an access card into one of said set of ATMs and providing a personal identification number (PIN), wherein the improvement consists of placing a device coupled to said network, which recognizes an alternate PIN entered into one of said set of ATMs and provides instructions on said network for restricting access to said at least one bank account when said alternate PIN is entered.

3. A method for protecting account holders during a transaction over a network including the steps of:
providing said account holder with a contingency access code;
placing contingency instructions on said network;
coupling a detection device to said network, wherein said detection device is able to detect where said contingency access code is entered during said transaction over a network; and
executing said contingency instructions when said contingency access code is entered.

4. An improved security access system which includes a security entry device including;
alternate security code entry means, capable of being entered into said security entry device;
alternate security code detection means coupled to said security entry device; and
alternate security instruction means responsive to said alternate security code detection means.

5. A method for providing security with an individual having access to a network including the steps of:
a step for placing a contingency code on a network, said individual informed of said contingency code; and
a step for protecting assets accessible over said network, when said contingency code is detected over said network.

6. The method as recited in claim 5, further including:
a step for notifying a party of the status of said individual.
